(19) United States
(12) Patent Application Publication
(10) Pub. No.: US 2026/0251311 A1
(43) Pub. Date: Aug. 27, 2026

(54) HEATING COOKER, HEATING AND COOKING METHOD, AND RECORDING MEDIUM

(71) Applicant: Panasonic Intellectual Property Management Co., Ltd., Osaka (JP)

(72) Inventors: Gantetsu MATSUI, Hyogo (JP); Shiki KOU, Shiga (JP); Hiroyoshi NOMURA, Shiga (JP)

(21) Appl. No.: 19/159,551

(22) PCT Filed: Feb. 20, 2024
(86) PCT No.: PCT/JP2024/006020

§ 371 Date: Aug. 25, 2025

(30) Foreign Application Priority Data
Mar. 31, 2023 (JP) 2023-058538

(51) Int. Cl. F24C 7/08; A47J 27/00; A47J 36/32; F24C 7/06; H05B 6/64

(52) U.S. Cl. CPC F24C 7/087; A47J 27/004; A47J 36/32; F24C 7/06; H05B 6/645

(57) ABSTRACT

A heating cooker includes: a heating chamber that heats food in the heating chamber; a first heater disposed at a bottom portion of the heating chamber; a second heater that is disposed at a top portion of the heating chamber; a temperature detector (detector) that detects a temperature distribution by sensing an interior of the heating chamber from above; and a heating controller that controls heating performed by the first heater and heating performed by the second heater, by using the temperature distribution detected. When the food is heated, the first heater starts heating before the second heater, the second heater starts heating after the first heater starts heating, and after the second heater starts heating, the heating controller adjusts a state of the heating performed by the first heater and a state of the heating performed by the second heater according to a change in the temperature distribution.

### TECHNICAL FIELD

The present disclosure relates to a heating cooker, a heating and cooking method, and a program.

### BACKGROUND ART

Cooking appliances and the like for heating food are in general use. In the past, cooking appliances to which a period of time is simply set and which heat food at a constant output only for the set period of time used to be common. In recent years, cooking appliances have also become popular which include automatic heating features that automatically perform heating for an appropriate period of time once food to be heated is placed and cooking is started. For example, Patent Literature (PTL) 1 discloses a heating cooker as one of the cooking appliances including such automatic heating features.

The heating cooker disclosed in PTL 1 includes: an object temperature detecting means for detecting the surface temperature of an object to be cooked (food) and a chamber temperature detecting means for detecting the temperature in the cooking chamber. A first threshold value for the detected temperature of the object temperature detection means and a second threshold value for the detected temperature of the chamber temperature detection means are set. When it is determined that either one of the two detected temperatures has reached the corresponding first threshold value or higher or second threshold value, the remaining time of microwave heating, which is the duration of microwave heating from the determination, is determined. This makes it possible to automatically cook the food placed in the cooking chamber without requiring inputs of the quantity of the food, heating time, heating temperature, and the like.

### CITATION LIST

[PTL 1] Japanese Unexamined Patent Application Publication No. 2021-167686

### SUMMARY OF INVENTION

### Technical Problem

However, the heating cooker disclosed in PTL 1 may not be capable of heating the food appropriately. The present disclosure provides a heating cooker and the like that is capable of heating food appropriately.

### Solution To Problem

A heating cooker according to one aspect of the present disclosure includes: a heating chamber that heats food placed in the heating chamber; a first heater that is disposed at a bottom portion of the heating chamber; a second heater that is disposed at a top portion of the heating chamber; a temperature detector that detects a temperature distribution of a detection region by sensing an interior of the heating chamber from above, the detection region including a region of the food placed in the heating chamber; and a heating controller that controls heating performed by the first heater and heating performed by the second heater, by using the temperature distribution detected. When the food is heated, the first heater starts heating before the second heater, the second heater starts heating after the first heater starts heating, and after the second heater starts heating, the heating controller adjusts a state of the heating performed by the first heater and a state of the heating performed by the second heater according to a change in the temperature distribution.

A heating and cooking method according to one aspect of the present disclosure is a heating and cooking method for heating and cooking food by using a heating cooker that is capable of heating the food placed in a heating chamber from above and below. The heating and cooking method includes: starting heating from a bottom portion of the heating chamber; starting heating from a top portion of the heating chamber after the starting of the heating from the bottom portion; and adjusting automatically a state of the heating from the bottom portion of the heating chamber and a state of the heating from the top portion of the heating chamber according to a change in a temperature distribution of a detection region after the starting of the heating from the top portion, the detection region including a region of the food seen from above.

A program according to one aspect of the present disclosure is a program for causing a computer to execute the heating and cooking method.

### Advantageous Effects of Invention

The heating cooker and the like according to the present disclosure is capable of heating food appropriately.

### BRIEF DESCRIPTION OF DRAWINGS

FIG. 1 is a block diagram illustrating a functional configuration of a heating cooker according to an embodiment.

FIG. 2 is a diagram for explaining temperature distributions of the heating cooker according to the embodiment.

FIG. 3 is a graph for explaining differences in temperature value obtained by the heating cooker according to the embodiment.

FIG. 4 is a flowchart illustrating an example of an operation of the heating cooker according to the embodiment.

FIG. 5 is a diagram for explaining examples of cases where the quantity is incorrectly determined and how to improve the accuracy of determination in the heating cooker according to the embodiment.

FIG. 6 is a flowchart illustrating an example of an operation of the heating cooker according to another example of the embodiment.

### DESCRIPTION OF EMBODIMENT

A heating cooker according to a first aspect of the present disclosure includes: a heating chamber that heats food placed in the heating chamber; a first heater that is disposed at a bottom portion of the heating chamber; a second heater that is disposed at a top portion of the heating chamber; a temperature detector that detects a temperature distribution of a detection region by sensing an interior of the heating chamber from above, the detection region including a region of the food placed in the heating chamber; and a heating controller that controls heating performed by the first heater and heating performed by the second heater, by using the temperature distribution detected. When the food is heated, the first heater starts heating before the second heater, the second heater starts heating after the first heater starts heating, and after the second heater starts heating, the heating controller adjusts a state of the heating performed by the first heater and a state of the heating performed by the second heater according to a change in the temperature distribution.

Such a heating cooker is capable of obtaining the temperature distribution of the detection region when food is heated by the first heater before the second heater. The heating from below by the first heater tends to rise the temperature of the non-food region. In other words, within the detection region, the temperature rise is likely to be delayed only in the food region. The detected temperature distribution then provides the approximate shape of the food that is cooler than its surroundings. In this way, based on the approximate shape of the food obtained from the temperature distribution, subsequent heating from above and below can be performed with the second heater and the first heater together. For example, when the approximate shape of the food is used as the quantity of the food, the state of heating by the first heater and the state of heating by the second heater can be adjusted for heating and cooking according to changes in temperature distribution and based on the appropriate quantity of the food according to the highly accurate approximate shape of the food. For example, when automatic cooking is performed without obtaining the quantity of food, over-heating due to too small food or under-heating due to too large food may occur. However, according to the above, such overheating and underheating are unlikely to occur. Thus, food can be appropriately heated.

Moreover, the heating cooker according to a second aspect of the present disclosure is the heating cooker according to the first aspect and further includes: a receiver that receives an input of food information related to a type of the food. During a period from when the first heater starts heating until when the second heater starts heating, the heating controller: obtains a threshold value corresponding to the type of the food based on the food information received, the threshold value being used for calculating a quantity of the food for the type of the food by comparing a change in the temperature distribution and the threshold value; determines the quantity of the food by using the threshold value obtained and the change in the temperature distribution; and adjusts the state of the heating performed by the first heater and the state of the heating performed by the second heater according to the quantity determined.

With this, food information can be obtained by receiving an input. The obtained food information can then be used to obtain threshold values for different types of food. The quantity of food is determined from the approximate shape according to the threshold for each type of food. Based on the quantity, the state of heating by the first heater and the state of heating by the second heater can be adjusted for heating and cooking according to changes in temperature distribution. Thus, food can be appropriately heated.

Moreover, the heating cooker according to a third aspect of the present disclosure is the heating cooker according to the first aspect or the second aspect and further includes: a receiver that receives an input of food information related to a type of the food. After the second heater starts heating, the heating controller: determines a thickness of the food by using the temperature distribution obtained when the heating is performed by the second heater and the food information received; and adjusts the state of the heating performed by the first heater and the state of the heating performed by the second heater according to the thickness determined. The receiver according to the second aspect and the receiver according to the third aspect may be realized by different receivers or may be realized by a single receiver.

With this, food information can be obtained by receiving an input. The thickness of the food can then be determined by using the temperature distribution obtained when the food is heated by the second heater and the obtained food information. Specifically, when the second heater heats the food from above, heat is transferred differently to the top surface of the food (the surface of food closer to the second heater) and to the lateral sides of the food that intersect the top surface. In other words, the top and lateral surfaces of the food differ in the way the temperature rises. When the temperature detector is provided in an orientation that allows separate detection of the top and lateral regions, the sizes of the top and lateral regions (i.e., thickness) can be estimated by the difference in the way the temperature rises. Alternatively, when the food information includes information indicating that the food has a common shape except for the thickness, a difference in the approximate shape by the thickness portion may be detectable relative to the approximate shape of the food when the food has a common shape and has a minimum thickness. The thickness can be estimated by this approximate difference in thickness. Thus, the thickness of the food can be estimated by using the temperature distribution obtained when the food is heated by at least the second heater, and the thickness of the food can also be estimated by another approach depending on the food information. Thus, the estimated thickness can also be used to appropriately heat the food.

The heating cooker according to a fourth aspect of the present disclosure is the heating cooker according to the third aspect. The heating controller: performs heating by using only the second heater during a period from when the second heater starts heating until when the heating controller starts adjusting both the state of the heating performed by the first heater and the state of the heating performed by the second heater; determines the thickness of the food by using the temperature distribution obtained when heating is performed only by the second heater and the food information received; and adjusts the state of the heating performed by the first heater and the state of the heating performed by the second heater according to the thickness determined.

With this, in estimating the thickness of the food based on the temperature distribution obtained when the food is heated by the second heater, it is possible to reduce an influence from the heating by the first heater that might act as noise. In other words, the thickness can be estimated more accurately.

The heating cooker according to a fifth aspect of the present disclosure is the heating cooker according to any one of the first aspect to the fourth aspect and further includes: a receiver that receives an input of food information related to a type of the food. During a period from when the first heater starts heating until when the second heater starts heating, the heating controller: determines a shape of the food by using the food information and the temperature distribution, and using the shape determined as a quantity of the food, adjusts the state of the heating performed by the first heater and the state of the heating performed by the second heater according to the quantity. The receiver according to the fifth aspect, the receiver according to the second aspect, and the receiver according to the third aspect may be realized by different receivers, may be realized by a single receiver, or two of the receivers may be realized by a single receiver.

With this, food information can be obtained by receiving an input. The approximate shape of the food (shape in this case) is determined from the type of food and temperature distribution based on the food information. By using the shape in the determination result as the quantity of the food, heating and cooking can be performed while adjusting the state of the heating performed by the first heater and the state of the heating performed by the second heater according to a change in the temperature distribution based on the quantity of the food. Thus, the food can be appropriately heated.

A heating and cooking method according to a sixth aspect of the present disclosure is a heating and cooking method for heating and cooking food by using a heating cooker that is capable of heating the food placed in a heating chamber from above and below. The heating and cooking method includes: starting heating from a bottom portion of the heating chamber; starting heating from a top portion of the heating chamber after the starting of the heating from the bottom portion; and adjusting automatically a state of the heating from the bottom portion of the heating chamber and a state of the heating from the top portion of the heating chamber according to a change in a temperature distribution of a detection region after the starting of the heating from the top portion, the detection region including a region of the food seen from above.

With this, it is possible to produce the same advantageous effects as the heating cooker described above.

Moreover, the heating and cooking method according to a seventh aspect of the present disclosure is the heating and cooking method according to the sixth aspect and further includes: receiving an input of food information related to a type of the food; and determining, after the starting of the heating from the top portion, a thickness of the food by using the temperature distribution obtained when heating is performed from the top portion of the heating chamber and the food information received. In the adjusting, the state of the heating from the bottom portion of the heating chamber and the state of the heating from the top portion of the heating chamber are automatically adjusted according to the thickness determined.

With this, it is possible to produce the same advantageous effects as the heating cooker according to the third aspect.

Moreover, the heating and cooking method according to an eighth aspect of the present disclosure is the heating and cooking method according to the seventh aspect and further includes: performing heating from only the top portion of the heating chamber, after the starting of the heating from the top portion and before the adjusting. In the determining of the thickness, the thickness of the food is determined by using the temperature distribution obtained when heating is performed from only the top portion of the heating chamber and the food information received, and in the adjusting, the state of the heating performed from the bottom portion of the heating chamber and the state of the heating performed from the top portion of the heating chamber are automatically adjusted according to the thickness determined.

With this, it is possible to produce the same advantageous effects as the heating cooker according to the fourth aspect.

Moreover, a program according to a ninth aspect of the present disclosure is a program for causing a computer to execute the heating and cooking method according to any one of the sixth to eighth aspects.

With this, it is possible to produce the same advantageous effects as the heating cooker described above by using the computer.

It should be noted that these general and specific aspects may be implemented using a system, a method, an integrated circuit, a computer program, or a computer-readable recording medium such as a CD-ROM, or any combination of systems, methods, integrated circuits, computer programs, and recording media.

It should be noted that the embodiment described below shows a general or specific example. The numerical values, shapes, structural elements, the arrangement and connection of the structural elements, steps, the order of steps, etc., illustrated in the following embodiment are mere examples, and therefore do not limit the present invention. Moreover, among the structural elements in the embodiment below, the structural elements not described in independent claims will be described as arbitrary structural elements.

Note that the respective figures are schematic diagrams and are not necessarily precise illustrations. Accordingly, for example, scales and the like are not necessarily the same in the drawings. In the drawings, substantially the same configurations are identified with the same reference signs, and repeated descriptions may be omitted or simplified.

### (Embodiment)

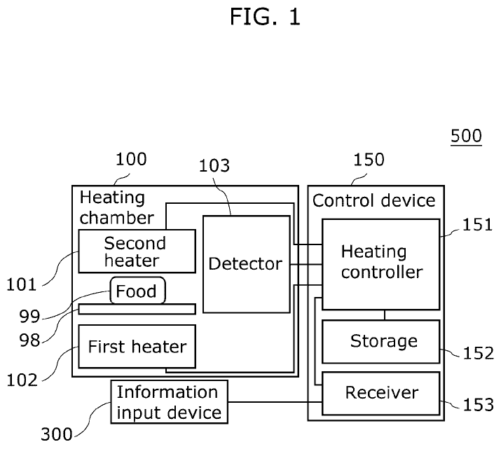

A heating cooker according to the present embodiment will be described below with reference to FIG. 1 to FIG. 6.

### [Configuration]

A configuration of the heating cooker according to the present embodiment will be described first with reference to FIG. 1 to FIG. 3. FIG. 1 is a block diagram illustrating a functional configuration of the heating cooker according to the embodiment. Heating cooker 500 according to the present embodiment may be any device capable of heating food 99, such as a microwave oven, a toaster oven, an induction heating (IH) grill, or a gas stove. Heating cooker 500 is a device that includes heaters on both sides of food 99 in a fixed direction penetrating food 99 placed at the heating position for heating. For example, in the present embodiment, heating cooker 500 includes heaters which are disposed on the top and bottom sides and between which food 99 is placed on placement table 98 in the top-bottom direction. In the present disclosure, terms indicating directions such as top, bottom, up, down, etc. do not mean the top-bottom direction (i.e., the vertical direction) in absolute space perception, but rather the direction connecting the plane that hits the bottom of heating chamber 100 and the plane that hits the top of heating chamber 100 when heating cooker 500 is placed in the use position.

As illustrated in FIG. 1, heating cooker 500 includes devices and the like that perform several functional parts. Specifically, heating cooker 500 includes heating chamber 100, control device 150, and information input device 300.

Heating chamber 100 is a container that houses food 99 when heating food 99, and is configured such that the energy for heating does not leak outside, or the energy is discharged only through the designed route. Heating chamber 100 serves as a major part of heating cooker 500. Heating cooker 500 includes a housing that covers heating chamber 100. Control device 150 and information input device 300 are integrally arranged in the housing. Information input device 300 may be realized by a terminal device such as a smartphone, or control device 150 may be realized by an information processing device such as an external server. There is no particular limitation on how each structural element of information input device 300 is distributed to one or more devices. In other words, in the present embodiment, an example in which respective structural elements are integrated into a single device is described. However, respective structural elements can also be distributed to two or more devices to realize a heating cooking system that performs the same functions as heating cooker 500.

The container portion of heating chamber 100 includes placement table 98 on which food 99 is placed, first heater 102, second heater 101, and detector 103. Placement table 98 is, for example, a turntable in a microwave oven or a grill plate in an IH grill. Placement table 98 is made of a hard material such as glass, resin, or metal. Placement table 98 generally has a specific heat lower than the specific heat of food 99. Therefore, when heating is started, the temperature of placement table 98 increases faster than the temperature of food 99.

First heater 102 is, for example, an IH heater. Any heater can be used as first heater 102 as long as the heater can be used as a heat source (or as long as the heater is capable of generating heat as a result even if the heater is not a heat source itself). First heater 102 is disposed at the bottom portion of heating chamber 100, in particular, on the side opposite to food 99 with placement table 98 between food 99 and first heater 102. Therefore, first heater 102 is capable of heating food 99 from below over placement table 98. In other words, food 99 is heated from the bottom portion of heating chamber 100 by first heater 102 disposed at the bottom portion of heating chamber 100. The heating operation of first heater 102 is controlled by heating controller 151.

Second heater 101 is, for example, a flat heater. Any heater can be used as second heater 101 as long as the heater can be used as a heat source (or as long as the heater is capable of generating heat as a result even if the heater is not a heat source itself). Second heater 101 is disposed at the top portion of heating chamber 100, e.g., on the inner surface of the ceiling side which is the uppermost plane of the interior space of heating chamber 100. Second heater 101 is capable of heating food 99 directly from above without placement table 98. In other words, food 99 is heated from the top portion of heating chamber 100 by second heater 101 disposed at the top portion of heating chamber 100. The heating operation of second heater 101 is controlled by heating controller 151.

Detector 103 is an example of a temperature detector, and is a sensor that detects a temperature distribution. Detector 103 uses, as a detection region, a plane orthogonal to the imaging direction according to the installation orientation, and detects temperature values at respective coordinates within the detection region. Detector 103 then outputs a matrix temperature distribution in which the detected temperature values are arranged in a two-dimensional plane corresponding to the detection region. Detector 103 is fixed so that, when food 99 is placed on placement table 98, the region of food 99 is included within the detection region based on the position of placement table 98. In other words, detector 103 detects the temperature distribution in a region that includes food 99 and the surroundings of food 99. In the present embodiment, detector 103 is disposed in heating chamber 100 so as not to be affected by the direct heat generated by first heater 102 and second heater 101. Specifically, detector 103 is disposed on, for example, any of one or more lateral surfaces connected to the top and bottom surfaces that are arranged in the top and bottom direction in the interior space of heating chamber 100, avoiding the top and bottom surfaces in the interior space of heating chamber 100. However, detector 103 is disposed on the upper side such that food 99 placed on placement table 98 is included in the detection region. Detector 103 is capable of transmitting the detected temperature distribution to heating controller 151. Here, the detection of the temperature distribution by detector 103 and heating controller 151 and the data processing of the temperature distribution will be described.

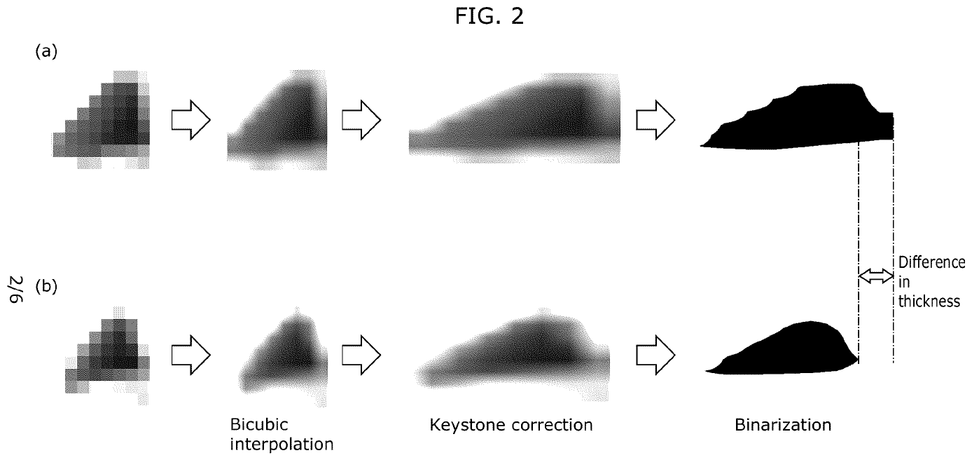

FIG. 2 is a diagram for explaining the temperature distributions of the heating cooker according to the embodiment. In FIG. 2, (a) illustrates an example of the temperature distribution obtained when one 4-sliced bread (one from a loaf of bread cut into four slices) is placed on placement table 98 as food 99 and heated. In FIG. 2, (b) illustrates an example of the temperature distribution obtained when one 8-sliced bread (one from a loaf of bread cut into eight slices) is placed on placement table 98 as food 99 and heated.

As illustrated in FIG. 2, each temperature distribution is illustrated as a thermal image in which the temperature values at respective points of 8×8=64 are represented in grayscale. In the present embodiment, detector 103 is thus a 64-point IR compound-eye sensor. The IR compound-eye sensor is excellent as detector 103 because it is inexpensive as a sensor and is capable of detecting temperatures as a distribution. Detector 103 is not limited to such an example. As detector 103, a higher-resolution IR sensor or a lower-resolution IR sensor may be used.

In FIG. 2, the closer the color is to white, the higher the temperature; the closer the color is to black, the lower the temperature. In other words, in FIG. 2, the black portion of each abbreviated triangle corresponds to the bread. Here, the thermal image obtained undergoes super resolution processing of Bicubic interpolation performed by an image processing circuit or processor included in heating controller 151 and further undergoes keystone correction. The thermal image of the detected temperature distribution is deformed into a trapezoidal shape because detector 103 is disposed so as to look down the bottom of placement table 98 from the top and lateral sides. Therefore, the keystone correction is used to restore the deformed trapezoid to its original rectangular shape. By binarizing the thermal image thus obtained, the pixels are divided into two portions that are a portion corresponding to the bread and a portion corresponding to the rest.

As illustrated in (b) of FIG. 2, when the thermal image of one 8-sliced bread after binarization is compared with the thermal image of one 4-sliced bread after binarization, it can be seen that the portions corresponding to the bread are different in size. This is because the temperature distributions are detected by detector 103 disposed on the top and lateral sides, so that the projected image of the 4-sliced bread is enlarged by the difference in thickness between the 4-sliced bread and the 8-sliced bread when projected onto the placement surface which is the top surface of placement table 98. In other words, the difference in projected image can be used as the difference in thickness of food 99.

In general, with an increase in the thickness of food 99, the heat output or heating time required for heating and cooking increases. In other words, first heater 102 and second heater 101 may be controlled to increase the heat output or extend the heating time by the thickness of food 99.

As described above, in the present embodiment, by detecting the temperature distribution of food 99, the thickness of food 99 as the quantity can be determined. By controlling the heating performed by first heater 102 and the heating performed by second heater 101 according to the result of the determination, it is possible to heat food 99 more appropriately than when the temperature in heating chamber 100 or the temperature of food 99 is simply detected. In order to calculate the thickness as accurately as possible, it may be that only heating from below is performed by first heater 102 and heating from above is not performed by second heater 101. This is due to the following reason. Most of the heat from first heater 102 is initially consumed to heat placement table 98, and food 99 is heated afterwards. Then, as illustrated in the thermal image in FIG. 2, a large temperature difference can be generated between food 99 and its surroundings, facilitating an accurate detection of the region of food 99 from the thermal image. At this time, when heating by second heater 101 is performed, the heat is supplied directly to food 99, and food 99 is heated at the same time as placement table 98. As a result, it is difficult to generate such a temperature difference.

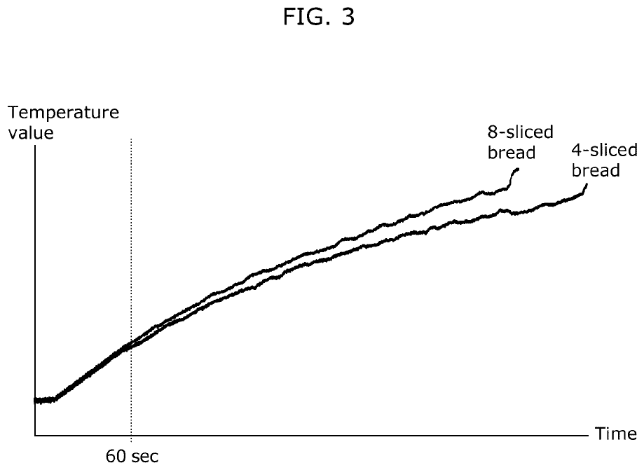

FIG. 3 is a graph for explaining the differences in temperature values obtained by the heating cooker according to the embodiment. FIG. 3 illustrates changes in temperature value at given points on the temperature distributions (given positions on food 99) with respect to the elapsed time from the start of heating when one 4-sliced bread and one 8-sliced bread are heated from below through placement table 98 using only first heater 102. As illustrated in FIG. 3, the temperature of one 8-sliced bread rises more easily than the temperature of one 4-sliced bread, and the difference reaches a detectable level in approximately 60 seconds. In other words, the difference in thickness can be detected by performing heating only by first heater 102 for approximately 60 seconds.

Although it has been described above that the thickness is used as the quantity, the quantity of food 99 may be determined by the shape (area value) of the portion corresponding to food 99 in the temperature distribution while ignoring the thickness. In other words, after the binarized thermal image is generated, the quantity of food 99 may be determined according to the total number of pixels (pixel number) corresponding to low-temperature food 99. When the type of food 99 is known along with the area value, it is possible to accurately determine what type of heating and cooking should be done. For example, it is possible to cook food 99 according to the characteristics of the type of food 99, such as the quantity of water retained by each type of food 99, the finish after cooking recommended for food 99 (texture such as fluffy or crispy), and so on. In other words, information related to the type of food 99 and the shape of food 99 may be used to control the heating operations of first heater 102 and second heater 101.

Control device 150 is a processor that performs various information processing in heating cooker 500, and is realized by a microcomputer or a processor. Control device 150 may be a device that is separate from the housing covering heating chamber 100. In such a case, control device 150 is realized, for example, by a cloud server for information processing provided by the manufacturer of heating cooker 500.

Control device 150 includes heating controller 151, storage 152, and receiver 153. Heating controller 151 is a processor that adjusts the state of heating performed by first heater 102 and the state of heating performed by second heater 101 by controlling the heating operations of first heater 102 and second heater 101. Heating controller 151 also serves as a processor that obtains the temperature distribution from detector 103 and performs various image processing. In addition, heating controller 151 also performs various determinations necessary to control the heating operations of first heater 102 and second heater 101. Heating controller 151 reads an appropriate heating sequence from among the heating sequences stored in storage 152 by using the results of such determinations and the like and outputs the read heating sequence to first heater 102 and second heater 101. First heater 102 and second heater 101 operate according to the heating sequence output from heating controller 151, so that an appropriate heating and cooking can be performed.

Storage 152 is an information storage device such as semiconductor memory, and is used to store the heating sequences described above and programs executed by heating controller 151.

Receiver 153 is a processor that receives an input of food information related to the type of food 99. Receiver 153 is either included in the same microcomputer as heating controller 151 or is realized by a program being executed in response to the information processing by the same processor as heating controller 151. Receiver 153 receives an input of information related to the type of food 99 made by user operation from information input device 300. Alternatively, receiver 153 may receive input of information related to the type of food 99 from an external device, such as an automatic food determination device that automatically determines the type of food 99 placed in heating chamber 100. The food information related to the type of food 99 received is used to obtain the threshold value corresponding to the type of food 99. The threshold value is used to calculate the quantity of food 99 according to type by comparing the threshold value with the detected change in temperature distribution. The obtained threshold value and the change in temperature distribution are used to determine the quantity of food 99, and the state of heating performed by first heater 102 and the state of heating performed by second heater 101 can be adjusted according to the determined quantity. The threshold value can be obtained by reading the threshold value from a database (not illustrated) that associates food with threshold values, or by receiving the threshold value from a data server (not illustrated) that provides a threshold value when queried with food as a query.

The above threshold values are specifically determined according to what food 99 is, and are for classifying the quantity into several graduated size ranges, such as large, medium, and small. When the food is bread, for example, numerical values of 10 cm and 15 cm in the lengthwise direction are obtained as threshold values. When the bread has a lengthwise length that is less than 10 cm, the bread is considered to be a small size and is cooked in a manner appropriate for the small-sized bread. When the bread has a lengthwise length that is at least 10 cm and less than 15 cm, the bread is considered to be a medium size and is cooked in a manner appropriate for the medium-sized bread. When the bread has a lengthwise length that is at least 15 cm, the bread is considered to be a large size and is cooked in a manner appropriate for the large-sized bread.

When the food is fish, for example, two values that are 10 cm and 20 cm in the lengthwise direction are obtained as threshold values and two values that are 5 cm and 7 cm in the widthwise direction are obtained as threshold values. In this case, the fish is determined to be one size larger when any of the lengthwise length and the widthwise length exceeds the threshold value. In other words, when the fish has a lengthwise length that is less than 10 cm and a widthwise length that is less than 5 cm, the fish is considered to be a small size and is cooked in a manner appropriate for the small-sized fish. When the fish meets one of the following lengths: the lengthwise length that is at least 10 cm and less than 20 cm; and the widthwise length that is at least 5 cm and less than 7 cm, the fish is considered to be a medium size and is cooked in a manner suitable for the medium-sized fish. When the fish meets one of the following lengths: the lengthwise length that is at least 20 cm; and the widthwise length that is at least 7 cm, the fish is considered to be a large size and is cooked in a manner appropriate for the large-sized fish.

In such a manner, in addition to the numerical value of the threshold value itself, the physical quantity and classification method may be set differently for each type of food 99 as the quantity to be classified by the threshold value. In other words, it may simply be classified by a lengthwise length threshold, by both lengthwise and widthwise length thresholds, by area value thresholds, etc., for each type of food 99. In addition, food information may also be used to estimate the thickness of the food along with the outline of the food.

In the present embodiment, information input device 300 is an operation panel on heating cooker 500, which is realized as a touch display or the like.

Information input device 300 may be a device that is separate from the housing covering heating chamber 100. In that case, information input device 300 is realized as a terminal device that includes an interface for information input, such as a smartphone or a tablet terminal owned by the user. Such a terminal device performs functions as part of heating cooker 500 by being communicatively connected to controller 150 by a wired or wireless communication line.

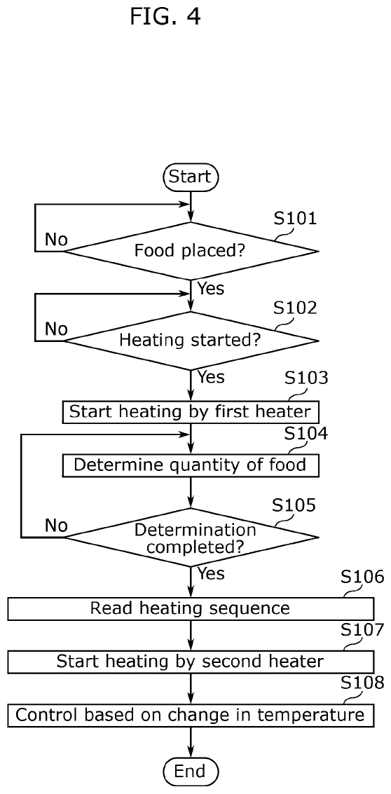

Next, an example of an operation of heating cooker 500 described above will be described with reference to FIG. 4. FIG. 4 is a flowchart illustrating an example of an operation of the heating cooker according to the embodiment. As illustrated in FIG. 4, when an operation of heating cooker 500 is started, first, control device 150 determines whether food 99 has been placed in heating chamber 100 (Step S101). Step S101 is repeated any number of times until Yes is made for step S101 (repeated while No is made for step S101). When food 99 is placed (Yes in step S101), control device 150 determines whether heating has started (step S102). Step S102 is repeated any number of times until Yes is made for step S102 (repeated while No is made for step S102). When heating has started (Yes in step S102), heating controller 151 causes first heater 102 to start heating (first heating step S103). Detector 103 detects the temperature distribution at that time. Heating controller 151 determines the quantity of food 99 based on the temperature distribution obtained (step S104). As long as the determination is not completed (No in step S105), steps S104 and S105 are repeated. When the determination is completed (Yes in step S105), heating controller 151 reads a heating sequence from storage 152 (step S106), and also causes second heater 101 to start heating (second heating step S107). According to the heating sequence, heating controller 151 controls the heating operations of first heater 102 and second heater 101 based on a change in temperature (step S108). This adjusts the state of heating performed by first heater 102 and the state of heating performed by second heater 101 (heating adjustment step).

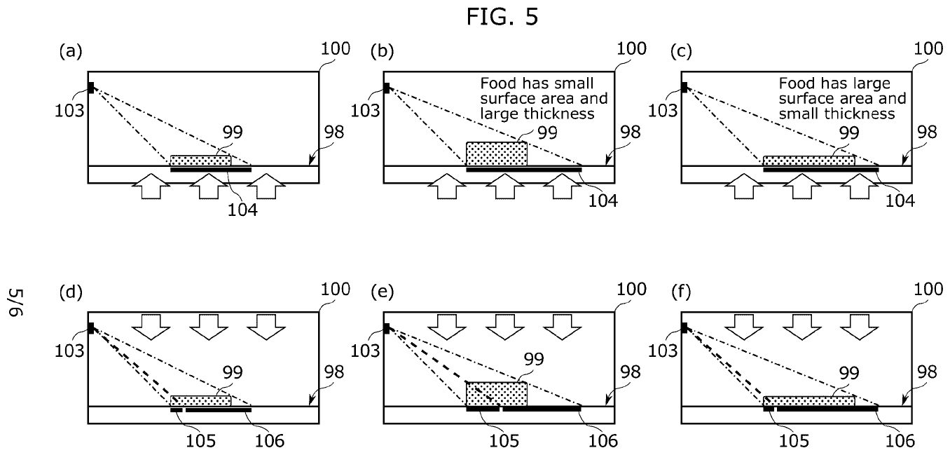

Here, the case where the thickness is used as the quantity of food 99 as described above will be further described with reference to FIG. 5. FIG. 5 is a diagram for explaining examples of cases where the quantity is incorrectly determined and how to improve the accuracy of determination in the heating cooker according to the embodiment. In FIG. 5, with three different sizes of food 99 placed in heating chamber 100, (a) to (c) illustrate the cases where heating is performed from below by first heater 102 and (d) to (f) illustrate the cases where heating is performed from above by second heater 101. The white arrows in FIG. 5 indicate the direction of the heat (direct heat) provided by the heating performed by first heater 102 or second heater 101.

As illustrated in (a) to (c) of FIG. 5, when heating is performed from below by first heater 102, the thickness can be obtained by the difference in surface area of the temperature distribution (black thick lines of projected images 104) between (a) and (b) of FIG. 5 where the shapes of the placement surfaces (shapes of the contact surfaces to placement table 98) are the same. However, an example of projected image 104 similar to the one illustrated in (b) of FIG. 5 is food 99, as illustrated in (c) of FIG. 5, with a thickness that is relatively small and a placement surface that is large. With the heating from below performed by first heater 102, it is difficult to distinguish food 99 that have the same projected image 104 as described above. In view of this, as illustrated in (d) to (f) of FIG. 5, when heating is performed from above by second heater 101, a difference in temperature value is generated between the top and lateral surfaces of food 99 detected by detector 103 due to the difference in the way food 99 receives heat from above. By using the feature, food 99 is heated only by second heater 101 (interrupting heating by first heater 102). As a result, projected image 105 on the side closer to detector 103 than the dashed line corresponding to the boundary between the top and lateral surfaces can be used as the projected image corresponding to the thickness, and projected image 106 on the side opposite to detector 103 relative to the dashed line can be used as the projected image corresponding to the size. This reduces incorrect determination of the quantity and improves the accuracy of the determination. The above example illustrates the case where heating is performed only by second heater 101 while interrupting the heating by first heater 102 in order to determine the thickness. However, the heating by first heater 102 does not have to be interrupted. For example, the intensity of the heating by first heater 102 may be reduced to the extent that the thickness can be determined without interrupting the heating by first heater 102.

As a condition for using the thickness as the quantity of food 99 as described above, a condition related to the shape of food 99 may be required. Therefore, for example, food information that includes, as a condition related to the shape of food 99, characteristics indicating that only the thickness of food 99 is unknown (and the rest has a common shape) may be received and the input may be used for determining the thickness.

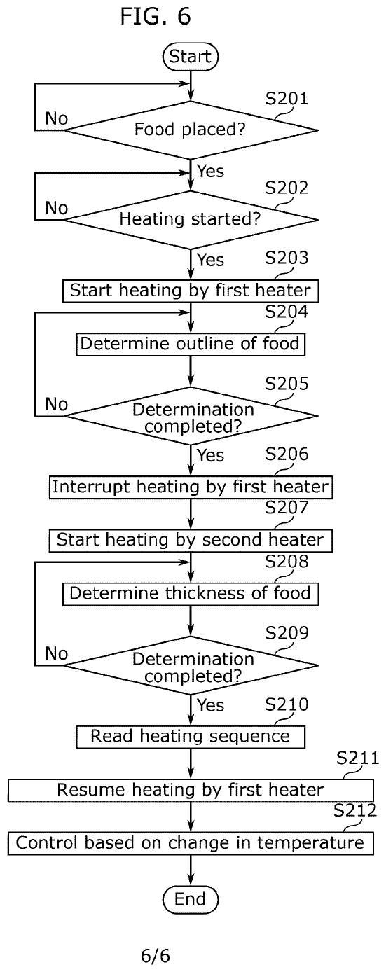

An example of an operation of heating cooker 500 according to another example of the embodiment based on this finding will be described below with reference to FIG. 6. FIG. 6 is a flowchart of an example of an operation of the heating cooker according to another example of the embodiment. Step S201 in FIG. 6 is identical to step S101, step S202 in FIG. 6 is identical to step S102, and first heating step S203 in FIG. 6 is identical to first heating step S103, so the descriptions thereof will be omitted.

As illustrated in FIG. 6, in step S204, heating controller 151 determines the outline of the food. The outline of the food is the portion corresponding to the region of food 99 in the temperature distribution obtained only by heating from below performed by first heater 102. As long as the determination of the outline of food 99 is not completed (No in step S205), steps S204 and S205 are repeated. When the determination of the outline of food 99 is completed (Yes in step S205), the processing proceeds to step S206, and the heating by first heater 102 is temporarily interrupted. Then, only heating from above by second heater 101 is started (second heating step S207), and the thickness of food 99 is determined by using the projected image of food 99 on the lateral side (step S208). The approximate shape and thickness may be determined by calculation using the food information and the outline of the food. As long as the determination of the thickness of food 99 is not completed (No in step S209), steps S208 and S209 are repeated. When the determination of the thickness of food 99 is completed (Yes in step S209), the processing proceeds to step S210. Since step S210 in FIG. 6 is identical to step S106, the description thereof will be omitted. Heating by first heater 102 is also resumed (step S211). Then, according to the heating sequence, the heating operations of first heater 102 and second heater 101 are controlled based on the change in temperature (step S212). This adjusts the state of heating performed by first heater 102 and the state of heating performed by second heater 101 (heating adjustment step).

Step S206 (interruption of heating by first heater 102) is not always required and may be omitted along with corresponding step S211 (resumption of heating by first heater 102). Alternatively, in step S206, the intensity of the heating by first heater 102 may be reduced without interrupting the heating by first heater 102. In this case, the intensity of heating by first heater 102 may be restored in step S211, or step S211 may be omitted and the intensity of heating may be adjusted during the control according to the heating sequence in step S212. Furthermore, step S206 may be performed after second heating step S207 or at the same time as second heating step S207, instead of being performed after Yes is made in step S205 and before second heating step S207. Step S206 and step S211 may be performed at any time as long as at least the period during which heating by first heater 102 is not being performed overlaps with the period after heating by second heater 101 is started. Depending on the heating sequence used thereafter, heating by first heater 102 may not be resumed. In other words, heating by first heater 102 may be terminated rather than interrupted. In that case, the step of terminating the heating performed by first heater 102 is performed instead of step S206, and step S211 is not performed.

### (Other Embodiments)

Although the heating cooker and the like according to the embodiment of the present disclosure has been described above, the present disclosure is not limited to the embodiment.

For example, each processor included in the heating cooker according to the embodiment described above is typically realized as a large scale integration (LSI) which is an integrated circuit (IC). They may be individually configured as single chips or may be configured so that part or all of the functions are included in a single chip.

Moreover, the integrated circuit is not limited to the LSI, and may be realized by a dedicated circuit or a general-purpose processor. A field programmable gate array (FPGA) which can be programmed after the manufacture of LSI or a reconfigurable processor in which the connection and settings of circuit cells inside the LSI can be reconfigured may be used.

In the above embodiment and the like, each structural element may be configured by dedicated hardware or may be realized by executing a software program suitable for each structural element. Each structural element may be realized by a program execution unit, such as a CPU or a processor, reading and executing a software program recorded on a recording medium, such as a hard disk or a semiconductor memory.

Moreover, an aspect of the present disclosure may be realized as, for example, a heating and cooking method executed by the heating cooker or a method of controlling the heating cooker. Moreover, an aspect of the present disclosure may be a computer program for causing a computer to execute respective characteristic steps included in the heating and cooking method or the control method.

Moreover, the heating cooker according to the embodiment and the like described above may be realized by a single device, or by a plurality of devices. When the heating cooker is realized by a plurality of devices, the structural elements included in the heating cooker may be distributed to the plurality of devices in any manner. For example, the control device may be included in a mobile terminal. Moreover, for example, at least one of the functional configuration of the control device may be realized by a mobile terminal or a server (such as a cloud server) that can communicate with the mobile terminal. In the case where the heating cooker is realized by a plurality of devices, the communication method between the plurality of devices is not particularly limited, but may be wireless communication or the wired communication. Moreover, the wireless communication and the wired communication may be combined between the devices.

Furthermore, the separation of the function blocks in the block diagrams is merely an example, and plural function blocks may be implemented as a single function block, a single function block may be separated into plural function blocks, or part of functions of a function block may be transferred to another function block. Furthermore, the functions of function blocks having similar functions may be processed, in parallel or in a time division manner, by a single hardware or software.

Furthermore, the sequence in which respective steps included in the flowcharts are executed is given as an example to describe the present disclosure in specific terms, and thus other sequences are possible. Part of the above-described steps may be executed simultaneously (in parallel) with another step.

The present disclosure is not limited to one or more aspects described above. A form obtained by making various modifications conceivable by those skilled in the art to the embodiment, and a form realized by combining the structural elements in different embodiments without departing from the gist of the present disclosure may also be included in the scope of one or a plurality of aspects.

### INDUSTRIAL APPLICABILITY

The present disclosure is applicable to heating cookers.

### REFERENCE SIGNS LIST

98 placement table
99 food
100 heating chamber
101 second heater
102 first heater
103 detector
104, 105, 106 projected image
150 control device
151 heating controller
152 storage
153 receiver
300 information input device
500 heating cooker

1. A heating cooker comprising:
a heating chamber that heats food placed in the heating chamber;
a first heater that is disposed at a bottom portion of the heating chamber;
a second heater that is disposed at a top portion of the heating chamber;
a temperature detector that detects a temperature distribution of a detection region by sensing an interior of the heating chamber from above, the detection region including a region of the food placed in the heating chamber; and
a heating controller that controls heating performed by the first heater and heating performed by the second heater, by using the temperature distribution detected,
wherein, when the food is heated,
the first heater starts heating before the second heater,
the second heater starts heating after the first heater starts heating, and
after the second heater starts heating, the heating controller adjusts a state of the heating performed by the first heater and a state of the heating performed by the second heater according to a change in the temperature distribution.

2. The heating cooker according to claim 1, further comprising:
a receiver that receives an input of food information related to a type of the food,
wherein, during a period from when the first heater starts heating until when the second heater starts heating, the heating controller:
obtains a threshold value corresponding to the type of the food based on the food information received, the threshold value being used for calculating a quantity of the food for the type of the food by comparing a change in the temperature distribution and the threshold value;
determines the quantity of the food by using the threshold value obtained and the change in the temperature distribution; and
adjusts the state of the heating performed by the first heater and the state of the heating performed by the second heater according to the quantity determined.

3. The heating cooker according to claim 1, further comprising:
a receiver that receives an input of food information related to a type of the food,
wherein, after the second heater starts heating, the heating controller:
determines a thickness of the food by using the temperature distribution obtained when the heating is performed by the second heater and the food information received; and
adjusts the state of the heating performed by the first heater and the state of the heating performed by the second heater according to the thickness determined.

4. The heating cooker according to claim 3,
wherein the heating controller:
performs heating by using only the second heater during a period from when the second heater starts heating until when the heating controller starts adjusting both the state of the heating performed by the first heater and the state of the heating performed by the second heater;
determines the thickness of the food by using the temperature distribution obtained when heating is performed only by the second heater and the food information received; and
adjusts the state of the heating performed by the first heater and the state of the heating performed by the second heater according to the thickness determined.

5. The heating cooker according to claim 1, further comprising:
a receiver that receives an input of food information related to a type of the food,
wherein, during a period from when the first heater starts heating until when the second heater starts heating, the heating controller:
determines a shape of the food by using the food information and the temperature distribution, and
using the shape determined as a quantity of the food, adjusts the state of the heating performed by the first heater and the state of the heating performed by the second heater according to the quantity.

6. A heating and cooking method for heating and cooking food by using a heating cooker that is capable of heating the food placed in a heating chamber from above and below, the heating and cooking method comprising:
starting heating from a bottom portion of the heating chamber;
starting heating from a top portion of the heating chamber after the starting of the heating from the bottom portion; and
adjusting automatically a state of the heating from the bottom portion of the heating chamber and a state of the heating from the top portion of the heating chamber according to a change in a temperature distribution of a detection region after the starting of the heating from the top portion, the detection region including a region of the food seen from above.

7. The heating and cooking method according to claim 6, further comprising:
receiving an input of food information related to a type of the food; and
determining, after the starting of the heating from the top portion, a thickness of the food by using the temperature distribution obtained when heating is performed from the top portion of the heating chamber and the food information received,
wherein, in the adjusting, the state of the heating from the bottom portion of the heating chamber and the state of the heating from the top portion of the heating chamber are automatically adjusted according to the thickness determined.

8. The heating and cooking method according to claim 7, further comprising:
performing heating from only the top portion of the heating chamber, after the starting of the heating from the top portion and before the adjusting,
wherein, in the determining of the thickness, the thickness of the food is determined by using the temperature distribution obtained when heating is performed from only the top portion of the heating chamber and the food information received, and
in the adjusting, the state of the heating performed from the bottom portion of the heating chamber and the state of the heating performed from the top portion of the heating chamber are automatically adjusted according to the thickness determined.

9. A non-transitory computer-readable recording medium having recorded thereon a computer program for causing a computer to execute the heating and cooking method according to claim 6.
